(19) United States
(12) Patent Application Publication
(10) Pub. No.: US 2008/0203244 A1
(43) Pub. Date: Aug. 28, 2008

(54) RADIANT FLOOR TUBING COLLECTOR AND ORGANIZER

(76) Inventor: Gordon Nagus, Saskatoon (CA)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 11/864,964

(22) Filed: Sep. 29, 2007

(30) Foreign Application Priority Data
Feb. 23, 2007 (CA) 2580058

(51) Int. Cl. F16L 3/22

(52) U.S. Cl. 248/68.1

(57) ABSTRACT

A collector holding conduits, such as tubing for a radiant floor heating system, in place and changing the direction of the conduits from a vertical direction to a horizontal direction is provided. The collector has: a substantially flat bottom edge; a first side; a second side; a first guide channel and a second guide channel. The first guide channel runs in a first direction at a first opening and transitions along its length to run in a second direction at a second opening. The second guide channel runs in a first direction at a first opening and transitions along its length to run in a second direction at the second opening. The first direction is substantially perpendicular to the second direction.

This invention is in the field of devices for aiding in the installation of radiant floor conduit runs and more particularly for a guide and collector for radiant floor conduits.

### BACKGROUND

Radiant floor heating is a commonly used method of heating a building. Although there are a number of different ways to install radiant floor heating, ideally in lower levels, basements and garages the radiant floor is installed right in the concrete slab. Before a concrete slab is poured, runs of radiant tubing or pipe (such as PEX tubing) are positioned on the ground surface where the concrete slab will be poured (typically, tied to the rebar already set in place to secure the radiant pipe in place while the concrete slab is being poured). When the pipe is positioned in place in the floor, the concrete slab is poured over the pipe. When the concrete sets, the slab then contains runs of pipe extending out of the concrete slab that can be connected to a supply of heated fluid to radiantly heat the concrete slab and thereby the space.

Usually a number of different runs of pipe are used in a radiant floor heating system. Each run consists of a supply portion, which carries heated fluid out into the slab, and a return portion, which carries the fluid back out of the slab. A number of different runs of pipe can be used to control the amount of heat going to different areas in the concrete slab. For example, to heat a bathroom and a living room with different amounts, a single run of pipe can be used to heat the bathroom allowing the temperature of the bathroom to be controlled separately from a living room that is heated by a different run of pipe. Additionally, the length of a run of pipe is limited because too long of a run of pipe can cause significant friction loss in the pipe causing excess temperature differentials in the run of pipe and therefore in the room or rooms being heated by the run of pipe. Rooms that are too large to heat with a single run of pipe use two or more runs of pipe to heat the space.

This means that there are typically a number of runs of pipe used in a concrete slab to radiantly heat a space. The exact number of different runs that are used will vary based on the size of the area to be heated as well as the how much control over the system is desired. Each run of pipe starts and ends at a location where a manifold will be installed. When the runs of pipe are positioned in place where the concrete slab will be poured, the starts and ends of the runs will have to be bent from vertical (running to the place where the manifold will be installed) to horizontal (the direction they will be running in, in the concrete slab). To do this the pipe or tubing used for the runs of pipe must be bent up to change its direction 90°, leaving the ends of the pipe sticking up so that when the concrete slab is poured, these ends are left sticking out of the concrete slab and can eventually be connected to a manifold.

The problem with this installation method is that the pipe or tubing used can only be bent to a certain angle. Bending it at too great an angle will cause it to kink in the pipe and tubing which can impede the flow of fluid through the pipe or tubing. If an installer bends it too much, the pipe will be damaged. However, the pipe must change direction from running vertically to running horizontally at the location where the tubing will be connected to the manifold. This presents a challenge to installers. Presently, most installers jury-rig a system of trying to hold the ends of the pipe in location or use various guides, etc.

### SUMMARY OF THE INVENTION

It is an object of the present invention to provide a device that addresses problems in the prior art.

In an aspect, an apparatus is provided for holding conduits for in place. The apparatus comprises: a substantially flat bottom edge; a first side; a second side; a first guide channel open at the first side of the apparatus and sized to accept a conduit, the first guide channel having a length with a first opening at a first end of the first guide channel and a second opening at a second end of the first guide channel, the first guide channel running in a first direction at the first opening and transitioning along the length of the first guide channel to run in a second direction at the second opening; and a second guide channel open at the first side of the apparatus and sized to accept a conduit, the second guide channel having a length with a first opening at a first end of the second guide channel and a second opening at a second end of the second guide channel, the second guide channel running in a first direction at the first opening and transitioning along the length of the second guide channel to run in a second direction at the second opening; wherein the first direction is substantially perpendicular to the second direction.

In another aspect, a system for holding a number of runs of conduit in place is provided. The system comprises: a first apparatus comprising: a substantially flat bottom edge; a first side; a second side; a first guide channel open at the first side of the apparatus and sized to accept a conduit, the first guide channel having a length with a first opening at a first end of the first guide channel and a second opening at a second end of the first guide channel, the first guide channel running in a first direction at the first opening and transitioning along the length of the first guide channel to run in a second direction at the second opening; and a second guide channel open at the first side of the apparatus and sized to accept a conduit, the second guide channel having a length with a first opening at a first end of the second guide channel and a second opening at a second end of the second guide channel, the second guide channel running in a first direction at the first opening and transitioning along the length of the second guide channel to run in a second direction at the second opening; wherein the first direction is substantially perpendicular to the second direction and wherein the first side is connectable to an other apparatus; at least one additional apparatus comprising: a substantially flat bottom edge; a first side; a second side; a first guide channel open at the first side of the apparatus and sized to accept a conduit, the first guide channel having a length with a first opening at a first end of the first guide channel and a second opening at a second end of the first guide channel, the first guide channel running in a first direction at the first opening and transitioning along the length of the first guide channel to run in a second direction at the second opening; and a second guide channel open at the first side of the apparatus and sized to accept a conduit, the second guide channel having a length with a first opening at a first end of the second guide channel and a second opening at a second end of the second guide channel, the second guide channel running in a first direction at the first opening and transitioning along the length of the second guide channel to run in a second direction at the second opening; wherein the first direction is substantially perpendicular to the second direction and wherein the first side is connectable to an other apparatus; and a cover plate connectable to the first side of an additional apparatus such that the first guide channel and second guide channel of the additional apparatus are covered by the cover plate. The first side of the first apparatus is connected to the second side one of the at least one additional apparatus and each additional apparatus is connected to a previous one of the at least one additional apparatus and wherein a last additional apparatus is connected on the first side to the cover plate.

In another aspect a method of holding a plurality of runs of conduit in place is provided. The method comprises: providing an apparatus a substantially flat bottom edge; a first side; a second side; a first guide channel open at the first side of the apparatus and sized to accept a conduit, the first guide channel having a length with a first opening at a first end of the first guide channel and a second opening at a second end of the first guide channel, the first guide channel running in a first direction at the first opening and transitioning along the length of the first guide channel to run in a second direction at the second opening; and a second guide channel open at the first side of the apparatus and sized to accept a conduit, the second guide channel having a length with a first opening at a first end of the second guide channel and a second opening at a second end of the second guide channel, the second guide channel running in a first direction at the first opening and transitioning along the length of the second guide channel to run in a second direction at the second opening; wherein the first direction is substantially perpendicular to the second direction and wherein the first side is connectable to an other apparatus, for each run of conduit; for each run of conduit, inserting a supply run portion of the conduit in one of the first guide channel and the second guide channel of one of the apparatus and a return run portion of the conduit in the other of the first guide channel and the second guide channel of the one of the apparatus; and connecting the each of the apparatuses together.

A collector comprising a first guide channel and a second guide channel is provided. The collector aids in the installation of a radiant heating system by holding the ends of runs of radiant floor pipe or tubing (such as PEX pipe) in place while a concrete slab is poured over the runs of pipe. An installer inserts a first end of a run of pipe in one of the first channel guide or the second channel guide, places the run or pipe where it is desired in the floor for heating, and then inserts the other end of the run of pipe in the other of the first channel guide or second channel guide.

The collector changes the direction of the pipe inserted in the collector so that its direction changes from running horizontally along a ground surface to being oriented vertically, so that the ends of the runs of pipe end up oriented vertically, so that they can be connected to a manifold that will be located above the slab. The guide channels change direction gradually enough, so that pipe or tubing inserted in the guide channels will not be damaged by the bend formed in the pipe by the guide channels.

In a further aspect, the first guide channel and second guide channel are positioned so that pipe exiting the top of the connector is spaced substantially the same distance apart that it will be connected to a manifold. In a further aspect, a specific width of the connectors are used to so that pipe in the collectors are spaced apart to substantially match a standard spacing on a manifold that they will be connected to.

Each collector can be connected to another collector so that an installer can add as many runs of pipe or tubing that are required for the installation. With each additional run of pipe needed, an installer simply takes an additional connector and connects it to a previous connector.

In an aspect, the collector can enclose and protect the pipe or tubing at the surface of the cement slab after the cement slab is poured so that the tubing is protected from floor finishing equipment, etc.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is perspective view of a radiant floor conduit collector;

FIG. 2 is a side view of the collector of FIG. 1;

FIG. 3 is a perspective view of two collectors connected together;

FIG. 4 is front view of a collector; and

FIG. 5 is a perspective view of two collectors, connected together, facing in opposite directions.

### DETAILED DESCRIPTION OF THE ILLUSTRATED EMBODIMENTS

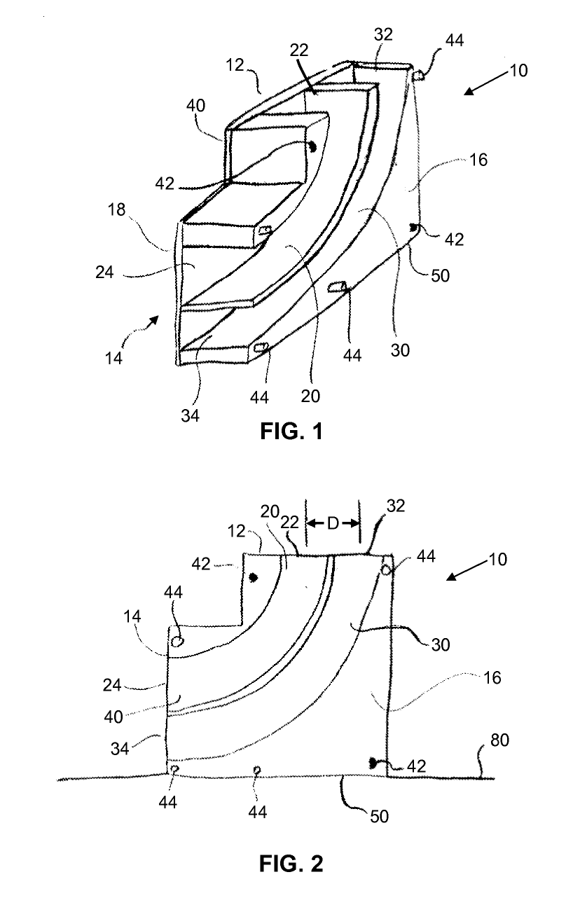

FIG. 1 illustrates a perspective view of a radiant floor conduit collector 10 for holding conduits such as radiant floor tubing or piping in place while a cement slab is poured around the collector 10. The collector 10 comprises: a top end 12; a bottom end 14; a first side 16; a second side 18; a first guide channel 20 having a top opening 22 and a bottom opening 24; a second guide channel 20 having a top opening 32 and a bottom 10 opening 34; a number of apertures 42; a number of dowels 44; and an end plate 40.

FIG. 2 illustrates a side view of the collector 10. The first guide channel 20 and second guide channel 30 are positioned in the collector 10 and sized to fit a desired size of conduit. The first guide channel 20 and second guide channel 30 are open on the first side 16 of the collector 10 so that conduit can be inserted into the first guide channel 20 and the second guide channel 30 through the opening on the first side 16. The first guide channel 20 has a top opening 22 at a top end 12 of the collector 10 and a bottom opening 24 at a bottom end 14 of the collector 10. The top opening 22 is positioned horizontally so that a conduit passing through the top opening 22 is oriented in a vertical direction 20 with respect to a ground surface 80 and the bottom opening 24 is positioned vertically so that a conduit (such as PEX tubing or pipe) passing through the bottom opening 24 is oriented in a horizontal direction with respect to the ground surface 80. The first guide channel defines a curved path that slowly changes the orientation of the first guide channel 20 from the vertical direction at the top end 12 to the horizontal direction at the bottom end 14 at a degree that will not damage a radiant floor conduit inserted into the first guide channel 20. In one aspect, the curved path follows a constant radius.

In this manner, a radiant floor conduit can be inserted into place in the first guide channel 20 through the open end on the first side 16 and the first guide channel 20 will change the direction of the conduit from a vertical direction at the top end 12 of the collector 10 (so that it can be connected to a manifold that supplies heated fluid) to horizontal at the bottom end 14 of the collector 10 with a gradual enough bend that the tubing used for the conduit will not be damaged.

The second guide channel 30 has a top opening 32 at the top end 12 of the collector 10 and a bottom opening 34 at the bottom end 14 of the collector 10. The top opening 32 is positioned horizontally, so that a conduit passing through the top opening 32 is oriented in a vertical direction, and the bottom opening 34 is positioned vertically, so that a conduit passing through the bottom opening 34 is oriented in a horizontal direction. Like the first guide channel 20, the second guide channel 30 defines a curved path that gradually changes the orientation of the first guide channel 20 from the vertical direction 20 at the top opening 32 to the horizontal direction at the bottom opening 34 changing the direction of the second guide channel 30 gradually enough so as not to damage a conduit inserted in the second guide channel 30. In one aspect, the curved path followed by the second guide channel 20 has a constant radius.

An end plate 40 is positioned on the second side 18 of the collector 10 so that when a conduit is slid into place in the first guide channel 20 and second guide channel 30, the conduit is held in place by the end plate 40. Typically, the end plate 40 is molded as an integral piece of the collector 10.

In operation, the collector 10 is used to position the end of a run of conduit so that it will extend out of a concrete slab that is poured over the run of conduit to form part of a radiant floor heating system. In one aspect, a portion of the top end 12 of the collector 10 can be left extending above a top surface of a poured concrete slab so that a conduit placed in the collector 10 can be completely enclosed at the top end 12 to prevent the conduit from being damaged by floor finishing materials or other devices during construction. A run of conduit is started with a supply portion starting from a location where a manifold will be installed. An installer inserts the supply portion of the conduit in either the first guide channel 20 or the second guide channel 30. At this point, the conduit will no longer be oriented downwards, but rather, the collector 10 will have altered the direction of the conduit so that it is oriented in a horizontal direction. The installer can then run the supply portion of the run of conduit out onto the ground surface where the cement slab will be poured. The run of conduit is then run back to the collector 10 and the location where the manifold will be installed in a return portion of the run of conduit. Once the run of conduit is back at the collector 10, the installer inserts the return portion of the run of conduit in the other of the second guide channel 30 and first guide channel 20 (the one that was not used to guide the supply portion of the conduit). If only a single run of conduit is being used for the radiant floor heating system, a cover plate (not shown) can be place on the side of the collector 10 to keep the conduit in the first guide channel 20 and the second guide channel 30 while the cement slab is being poured.

In one aspect, the top opening 22 of the first guide channel 20 is spaced a distance D 10 from the top opening 32 of the second guide channel 30 so that the ends of a run of conduit spaced substantially the same distance apart that they will need to be in order to connect to a standard spaced manifold that the conduits will eventually be connected to.

A bottom edge 50 of the collector 10 is flat and sized to be wide enough so that the 15 collector 10 will sit securely the ground surface 80 and support itself in place on the ground surface 80 while the concrete slab is being poured around the collector 10.

Each collector 10 is adapted to be attached to other collectors 10 using a set of apertures 42 and dowels 44 on the first side 16 and second side 18 of the collector 10.

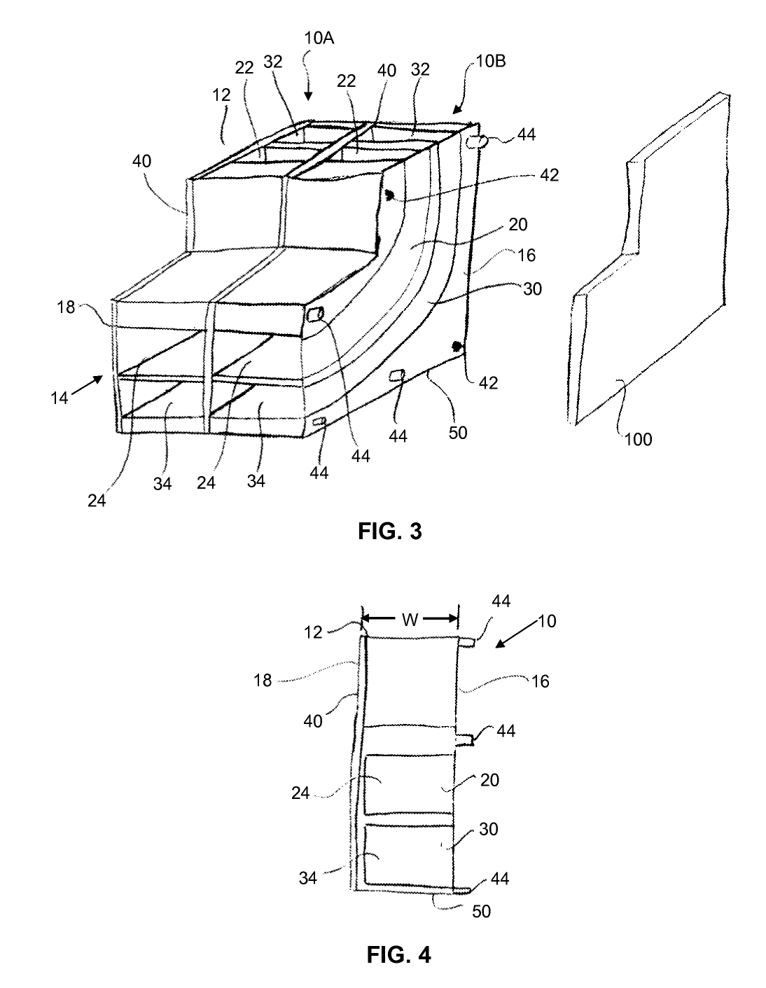

FIG. 3 illustrates two collectors 10A, 10B attached to each other to hold two runs of conduit for a radiant floor heating system. A first collector 10A is positioned to hold a first run of conduit, including a supply portion through either the first guide channel 20 or the second guide channel 30 and a return portion, through the other of the first guide channel 20 or second guide channel 30. Once the first run of conduit is positioned in the first collector 10A, the second collector 10B is then placed adjacent to the first side 16 of the first collector 10A and connected to the first collector 10A by mating the apertures 42 on the first side 16 of the first collector 10A with the dowels 44 on the second side 18 of the second collector 10B and the dowels 44 on the first side 16 of the first collector 10A with the apertures 42 on the second side 18 of the second collector 10B. The second side 18 of the second collector 10B now holds the first run of conduit in place in the first 10 guide channel 20 and second guide channel 30 of the first collector 10A by enclosing the open tops of the first guide channel 20 and the second guide channel 30.

A second run of conduit is then inserted in the second collector 10B and a cover plate 100 can then be connected to the first side 16 of the second collector 10B, using the apertures 42 and dowels 44 on that first side 16 of the second collector 10B, to hold the second run of conduit in place in the first guide channel 20 and the second guide channel 30 of the second collector 10B. With the first collector 10A and second collector 10B placed on a ground surface, holding the end of the two runs of conduit in place, the cement slab can be poured, encasing both the conduit runs and the first collector 10A and second collector 10B.

Although FIG. 3 illustrates two collectors 10A, 10B, any number of collectors 10 can be connected to accommodate any practical number of conduit runs for the radiant floor heating system by simply adding additional collectors 10. For each additional run of conduit used in the radiant floor heating system, an additional collector 10 can simply be added by connecting it to the previous collector 10, once the ends of a run of conduit are positioned in the previous collector 10. Once the ends of each run of conduit have been positioned in a collector 10, a cover plate 100 can be connected to the last connector 10, to hold the tubing run in the last connector 10, while the concrete slab is poured into place over the connectors 10.

FIG. 4 illustrates a side view of a collector 10. In one aspect, a width, W, of the collector 10 is used so that the spacing of the collectors 10 when they are connected together, substantially match a standard spacing of a manifold, which they will be connected to.

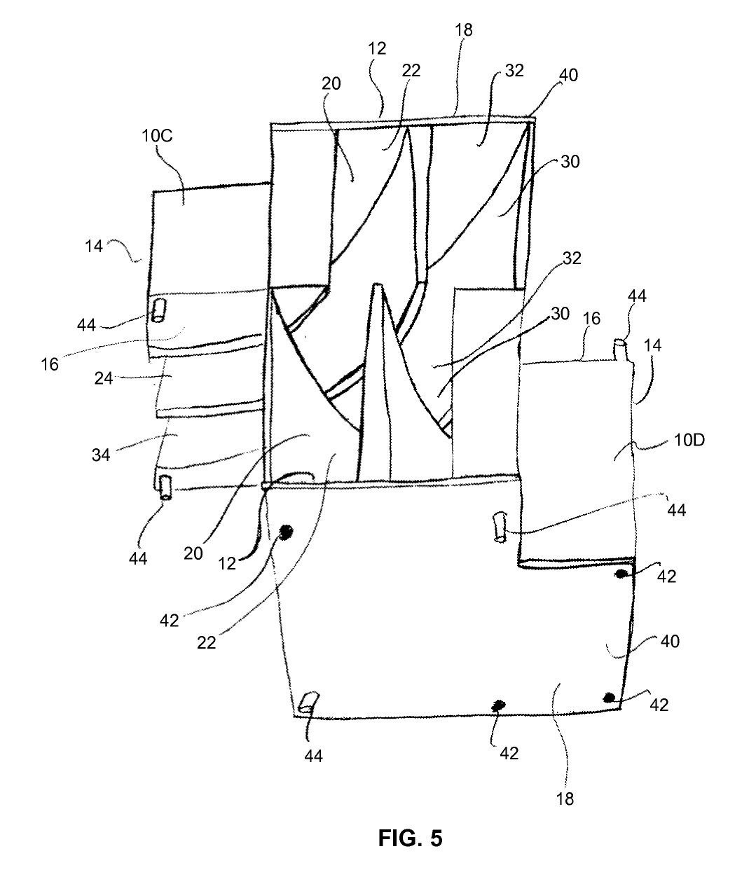

FIG. 5 illustrates a further aspect where two collectors 10C, 10D are attached to each other so that a first collector 10C has the bottom opening 24 of the first guide channel 20 and the bottom opening 34 of the second guide channel 30 facing in a first direction, while the bottom opening 24 of the first guide channel 20 and the bottom opening 34 of the second guide channel 30 of the second collector 10D, face in an opposite direction. The top opening 22 of the first guide channel 20 and the top opening 32 of the second guide channel 32 face in the same direction as the top opening 22 of the first guide channel 20 and the top opening 32 of the second guide channel 32 of the second collector 10D. In this manner, runs of conduit can be run in opposite directions from the manifold (such as when a manifold will be installed on an interior wall), yet still connected to the same manifold.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of lathe claimed invention.

What is claimed is:

1. An apparatus for holding conduits for in place, the apparatus comprising:
a substantially flat bottom edge; a first side; a second side;
a first guide channel open at the first side of the apparatus and sized to accept a conduit, the first guide channel having a length with a first opening at a first end of the first guide channel and a second opening at a second end of the first guide channel, the first guide channel running in a first direction at the first opening and transitioning along the length of the first guide channel to run in a second direction at the second opening; and
a second guide channel is open at the first side of the apparatus and sized to accept a conduit, the second guide channel having a length with a first opening at a first end of the second guide channel and a second opening at a second end of the second guide channel, the second guide channel running in a first direction at the first opening and transitioning along the length of the second guide channel to run in a second direction at the second opening;
wherein the first direction is substantially perpendicular to the second direction.

2. The apparatus of claim 1 wherein the first side is connectable to an other apparatus.

3. The apparatus of claim 2 wherein the first side of the apparatus is connectable to the second side of the other apparatus such that the second side of the other apparatus encloses the first guide channel and second guide channel of the apparatus when the other apparatus is connected to the apparatus.

4. The apparatus of claim 3 wherein the first side comprises at least one of: a plurality of dowels; and a plurality of apertures, and the first side of the apparatus connects to the second side of the other apparatus using corresponding apertures and dowels on the second side of the other apparatus.

5. The apparatus of claim 4 wherein the at least one of a plurality of dowels and a plurality of apertures are arranged on the first side so that a second side and a first side of an other apparatus is connectable to the first side of the apparatus.

6. The apparatus of claim 2 wherein the first opening of the first guide channel is spaced a distance from the first opening of the second guide channel and wherein the distance corresponds to a distance between connection points on a manifold that will be connected to a conduit running through the apparatus.

7. The apparatus of claim 2 wherein when the apparatus has a width and the width of the apparatus corresponds to connection points on a manifold that will be connected to conduits running through the apparatus.

8. The apparatus of claim 2 wherein the first direction is substantially perpendicular to a plane defined by the bottom edge and the second direction is substantially parallel to the plane device by the bottom edge.

9. The apparatus of claim 8 wherein the first guide channel follows a curved path from the first opening to the second opening of the first guide channel and the second guide channel follows a curved path from the first opening to the second opening of the second guide channel.

10. The apparatus of claim 9 wherein the curved path followed by the first guide channel has a constant radius along the length of the first guide path and the curved path followed by the second guide channel has a constant radius along the length of the second guide channel.

11. A system for holding a number of runs of conduit in place, the system comprising:
a first apparatus in accordance with claim 2;
at least one additional apparatus in accordance with claim 2; and
a cover plate connectable to the first side of an additional apparatus such that the first guide channel and second guide channel of the additional apparatus are covered by the cover plate;
wherein the first side of the first apparatus is connected to the second side one of the at least one additional apparatus and each additional apparatus is connected to a previous one of the at least one additional apparatus and wherein a last additional apparatus is connected on the first side to the cover plate.

12. The system of claim 11 wherein the first side of each apparatus is connectable the second side of a other apparatus such that the second side of the other apparatus encloses the first guide channel and second guide channel of the apparatus when the other apparatus is connected to the apparatus.

13. The system of claim 12 wherein the first side of each apparatus comprises at least one of: a plurality of dowels; and a plurality of apertures, and the first side of each apparatus connects to the second side of the other apparatus using corresponding apertures and dowels on the second side of the other apparatus.

14. A method of holding a plurality of runs of conduit in place, the method comprising:
providing an apparatus in accordance with claim 2 for each run of conduit;
for each run of conduit, inserting a supply run portion of the conduit in one of the first guide channel and the second guide channel of one of the apparatus and a return run portion of the conduit in the other of the first guide channel and the second guide channel of the one of the apparatus; and connecting the each of the apparatuses together.

15. The method of claim 14 further comprising providing a cover plate and connecting it to a last apparatus by connecting the cover plate to the first side of the last apparatus to cover the first guide channel and the second guide channel of the last apparatus.
